(19) United States
(12) Patent Application Publication
(10) Pub. No.: US 2022/0412390 A1
(43) Pub. Date: Dec. 29, 2022

(54) SOCKET WITH CLEAR THREADED PORTION FOR RECEIVING A FASTENING ELEMENT

(71) Applicant: EJOT SE & Co. KG, Bad Berleburg (DE)

(72) Inventor: Erhard Hackler, Bad Berleburg (DE)

(21) Appl. No.: 17/781,225

(22) PCT Filed: Nov. 16, 2020
(86) PCT No.: PCT/EP2020/082262

§ 371 Date: May 31, 2022

(30) Foreign Application Priority Data
Dec. 2, 2019 (DE) 10 2019 218 674.2

(51) Int. Cl. F16B 37/12

(52) U.S. Cl. CPC F16B 37/122

(57) ABSTRACT

A sleeve for receiving at least a portion of a fastening element is provided. The sleeve comprises an inner thread, which is partially formed by a helical notch within the sleeve, wherein the notch comprises restrictions in direction of a first and a second end of the sleeve. Furthermore, the inner thread comprises, at the area of a first turn adjacent to the first end of the sleeve, a restriction in direction of the second end, but no restriction in direction of the first end. Also, a system comprising a sleeve and a fastening element as well as a mandrel for manufacturing a sleeve are provided.

The current invention generally relates to a socket for receiving a fastening element.

Fastening elements are often times mounted in a substrate. Based on the composition of the substrate it is beneficial to place a socket in the substrate. Thereby, a predefined environment can be created in which the fastening element can be inserted. For example, the socket may comprise an inner thread in which a threaded portion of the fastening element may be screwed in for forming a form-fitting engagement between the threaded portion of the fastening element and the inner thread of the socket.

In particular, such sockets are used for offset mounting. For offset mounting, insulation boards, for example, are supported in a particular distance relatively to the substrate by ease of a fastening element. This may be achieved by a fastening element having two threaded portions, wherein a first threaded portion is used for anchoring the fastening element in the substrate and a second threaded portion is used for supporting the insulation board. For the fastening element being sufficiently secured in the substrate and for allowing the distance between the insulation board and the substrate being adjustable, often times a socket is placed within the insulation board. The second threaded portion of the fastening element then can engage with the socket and form a force-fitting engagement, whereas the outer surface of the socket is configured for supporting the insulation board. Depending on how far the second threaded portion is screwed into the socket, the distance of the insulation board to the substrate changes.

A socket may essentially be formed as a hollow cylinder, i.e. the socket comprises a body and a bore therein, wherein a helical notch is formed at the inner surface of the body. This notch forms an inner thread and is used as a reception for a threaded portion of a fastening element. When the fastening element is placed within the bore of the socket, the relative impact between the threaded portion and the notch is crucial for a form-fitting engagement. Usually, the notch of the socket and the threaded portion of the fastening element are single-start threads. This means that the inner thread is formed by a continuous notch. However, it is also possible to use a socket, which comprises a multi-start thread, which means a thread that is formed by multiple distinct, but intertwined helical notches.

In case of a single-start inner thread, the socket comprises one access to the notch at the end of the socket that faces the fastening element. For the threaded portion being able to engage with the notch, the start of the threaded portion of the fastening element needs to meet with the access. A precise impact of the threaded portion at the access to the notch is therefore only possible over a small range of impact angles. In case of a multi-start inner thread, each of the distinct, but intertwined helical notches comprises its own access. In this case, a corresponding fastening element comprises a threaded portion that is formed by multiple protrusions as well, which can each be screwed into one of the distinct notches of the multi-start thread.

Often times during the fixing of a fastening element, there is not sufficient time for arranging the relative position of the threaded portion and the access to the notch carefully. Further, in many cases this is difficult to achieve, for example in case that the view is blocked.

Therefore, it often occurs in practice that the start of the threaded portion of the fastening element does not enter the access of the notch of the socket during the fixing. This may result in the fastening element not entering the socket at all and instead pushing the socket out of the insulation board. Furthermore, it is possible that the threaded portion of the fastening element cuts into and damages the socket. Therefore, there is a risk that the intended form-fitting engagement of the fastening element and the socket is not achieved.

The object of the current invention is therefore to overcome the aforementioned drawbacks and to provide a socket which improves the entering of a threaded portion of the fastening element into an inner thread of the socket regardless of the impact position of the threaded portion relatively to the bore of the socket.

This object is solved by a socket, a system comprising a socket and a fastening element, as well as a mandrel for manufacturing a socket according to the invention as are set out in the independent claims of the current invention. Preferred and advantageous embodiments can be found in the dependent claims and the following description.

Even though the usage of the socket in the introductory portion of this description and in the following detailed description is described by way of example of offset mounting, this is only because the penetration of the threaded portion of the fastening element into the inner thread of the socket is of particular importance for this context and because a socket in an insulation board often times cannot be secured in the same way as in a masoned substrate. Nevertheless, the current invention is not limited to such applications but can be advantageously used in any situation in which a thread shall be inserted into a corresponding inner thread.

A socket according to the invention comprises an inner thread, which is formed at least partially by a helical notch in the socket, wherein the notch comprises restrictions in direction of a first and a second end of the socket. The inner thread may be located within a bore of the socket. Thereby, the notch may be suitable for engaging with a protrusion of a threaded portion of a fastening element and thereby forming a form-fitting engagement.

Generally, a socket denotes a body which has a clearance in which something can be arranged. Therefore, with regards to the invention, it may be said that the socket comprises a bore without specifying the particular configuration of the clearance or the process by which the clearance is formed. The clearance may, for example, be cylindrical. However, the person skilled in the art will be aware that the advantages of the invention can also be achieved with clearances that are shaped differently. The clearance can be formed during the manufacturing of the socket directly or in a subsequent step, in which the clearance, for example, can be drilled into the socket.

The socket according to the invention comprises two ends, wherein the clearance of the socket is accessible from at least one of the two ends of the socket. The end from which the clearance is accessible will in the following be referred to as the first end and this end will be the one from which a fastening element penetrates the clearance of the socket in direction of the second end, when the socket is used as intended. However, this does not exclude that a fastening element can additionally penetrate the clearance from the second end of the socket.

Generally, the notch can be a recess or a slot in the body of the socket within the clearance. Starting at the bottom of the notch, the notch is restricted by protrusions in two directions. These restrictions are a restriction in direction of the first and a restriction in direction of the second end of the socket. The restriction may, for example, be formed by thread flanks of the inner thread. Accordingly, the restrictions generally have a pitch relatively to the longitudinal extend of the socket, which essentially corresponds to the pitch of the inner thread and/or the threaded portion of the fastening element. The restrictions do not represent means that block the notch at one of the ends or on both ends, because the notch needs to be configured for allowing a threaded portion of the fastening element to be screwed into the notch.

The inner thread of the socket according to the invention, at an area of the first turn of the inner thread adjacent to the first end of the socket, comprises a restriction in direction of the second end, but does not comprise a restriction in direction of the first end. The restriction in direction of the second end may, for example, be formed by a thread flank of the inner thread. The area of the first turn may begin directly at the first end of the socket. According to the current invention, the area of the first turn may also be located adjacent to the first end in such a way that a further area is located between the first end and the area of the first turn. This further area may, for example, be an area without restrictions in direction of the first and second ends.

According to the current invention, a turn corresponds to one convolution of the inner thread. The first turn of the inner thread, i.e. the first convolution of the inner thread, is the turn which is arranged closest to the first end of the socket. This first turn distinguishes from the following turns, because the first turn does not have a restriction in direction of the first end. This allows the start of the threaded portion of the fastening element to impact the inner thread at any location of its first turn. This configuration of the invention causes the threaded portion of the fastening element to move along the inner thread until the start of the threaded portion penetrates the second turn in which the inner thread is restricted in both directions. Advantageously, the inner thread of the socket comprises the same or a similar pitch as the threaded portion of the penetrating fastening element.

Compared to a socket as known in the art, the socket according to the invention is characterized by that the inner thread does not comprise restriction in direction of the first end in the first turn. Hence, the inner thread does not comprise only one predefined, thin access area as is known from the sockets known in the art, but the inner thread is accessible over its entire first turn, i.e. an angle range of 360°. Therefore, it can be said that the first turn of the inner thread is cleared.

According to a preferred embodiment, the socket comprises an inner diameter in the area of the first turn that corresponds to the inner diameter of the socket in the area of a second turn plus two times the depth of the notch. This has the advantage that the transition from the first turn of the inner thread to the second turn of the inner thread is enabled.

In another preferred embodiment, the restriction in direction of the second end at the end of the first turn together with the restriction in direction of the second end at the start of the second turn forms a protrusion. Said protrusion preferably is formed wedge-shaped. Such a protrusion has the advantage that there is no disturbing face against which the protrusion of the threaded portion of a fastening element may strike during the transition from the first to the second turn of the inner thread.

In another preferred embodiment, the socket is cylindrical. For example, a body of the socket may be a cylindrical body. This has the advantage that the socket may be placed in a drillhole easily.

In another preferred embodiment, the socket at least partially consists of a plastic material. This has the advantage that the socket is easily deformable by the application of a force and therefore a form-fitting and force-fitting engagement between the socket and the substrate can be established. For example, the socket may be pushed radially against the substrate by the penetration of a fastening element.

Further, the object of the invention is also solved by a system according to the invention, wherein the system comprises a socket and a fastening element. The socket comprises an inner thread that is partially formed by a helical notch within the socket, wherein the notch comprises restrictions in direction of a first and a second end of the socket. Furthermore, the inner thread comprises, in an area of the first turn adjacent to the first end of the socket, a restriction in direction of the second end, but no restriction in direction of the first end.

In another preferred embodiment, the restriction in direction of the second end of the socket at the end of the first turn together the beginning of the second turn of the inner thread forms a wedge-shaped protrusion.

Furthermore, the socket of the system may be configured according to any of the preferred embodiments of the socket according to the invention that is described herein independently from the system.

Further, the object of the invention is also solved by a mandrel according to the invention for manufacturing a socket according to the invention. The mandrel according to the invention comprises a cylindrical body with a first end and a second end.

The cylindrical body further comprises a first portion with a first helical protrusion formed at the outer surface of the first portion for forming a helical notch of an inner thread in a socket. The first portion is arranged at the first end of the cylindrical body. The helical protrusion is restricted by thread flanks, wherein a first thread flank faces the first end of the cylindrical body and a second thread flank faces the second end of the cylindrical body.

Further, the cylindrical body comprises a second portion having a greater diameter than the first portion for forming an enlarged inner diameter within the socket. The second portion is arranged in the direction of the second end of the cylindrical body.

The cylindrical body further comprises a transition portion, which is arranged between the first portion and the second portion. The transition portion comprises a second helical protrusion, which extends along the cylindrical body for an entire turn and comprises the same pitch as the first helical protrusion. The second helical protrusion comprises a thread flank, which faces towards the first end of the cylindrical body and transitions form-fittingly to the first thread flank of the first protrusion. The second helical protrusion does not comprise a restriction in the direction of the second end of the cylindrical body.

In a preferred embodiment, the second helical protrusion restricts a wedge-shaped recess within the transition area. The advantage of such a wedge-shaped recess is that the mandrel by ease of the wedge-shaped recess is enabled to cut a wedge-shaped protrusion at the position of the transition area.

In another preferred embodiment, the second helical protrusion comprises two ends, wherein a first end forms the form-fitting transition of the thread flank of the second protrusion into the first thread flank of the first protrusion and wherein a connection line between the first end of the second helical protrusion and the second end of the second helical protrusion form the wedge-shaped recess. An advantage of this configuration is that when cutting the inner thread in a socket, no disturbing edges occur, which may later hinder the screwing in of a fastening element into the socket.

The appended drawings illustrate the socket, the system consisting of a socket and a fastening element and the mandrel according to the invention by ease of embodiment examples compared to corresponding elements known in the art. It shows:

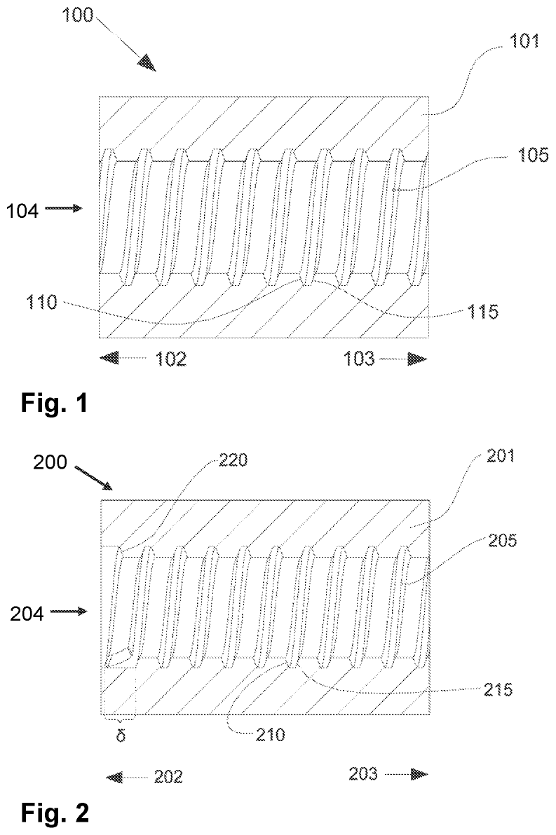

FIG. 1 cross-sectional view of a socket as known in the art,

FIG. 2 cross-sectional view of an embodiment of a socket according to the invention,

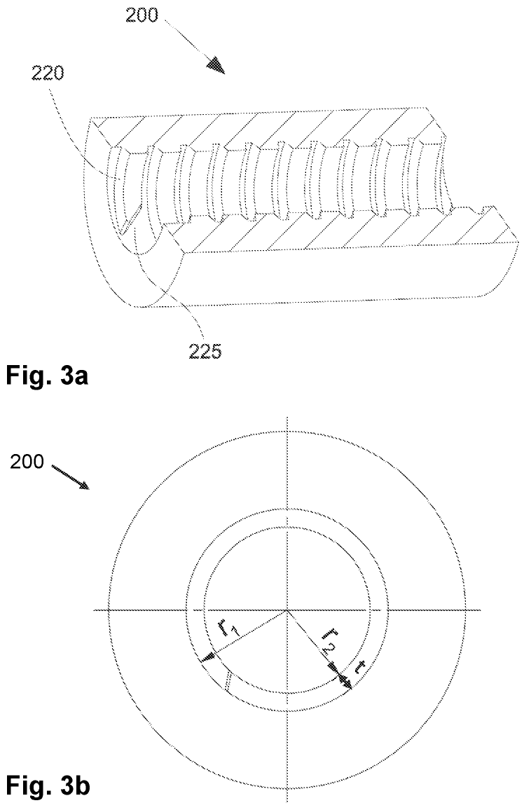

FIGS. 3a, 3b perspective views of a socket according to an embodiment of the invention cut longitudinally,

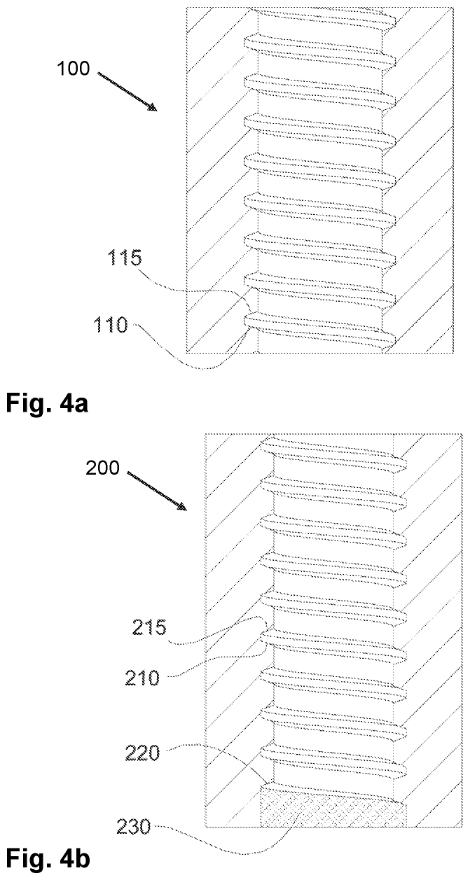

FIGS. 4a, 4b detailed view of restrictions of a notch of a socket as known in the art and a socket according to the invention, respectively,

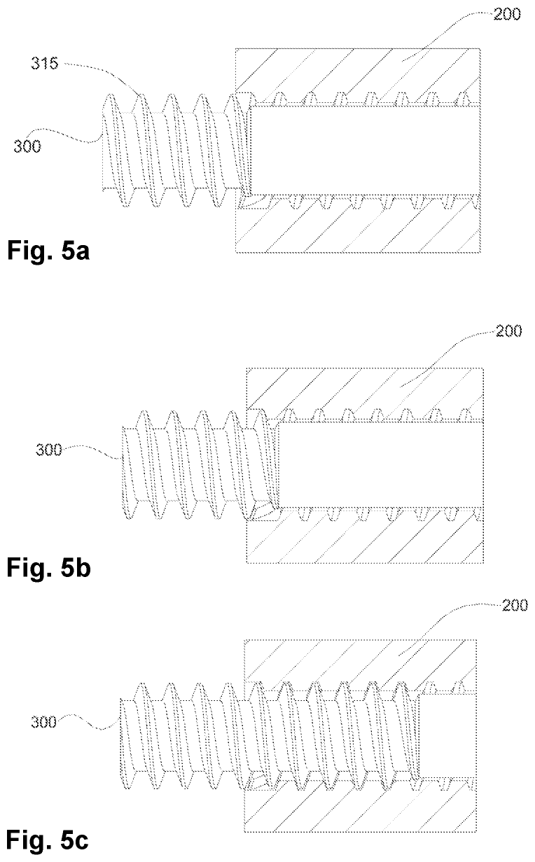

FIGS. 5a-c illustration of the penetration of a fastening element into a socket according to the invention, and

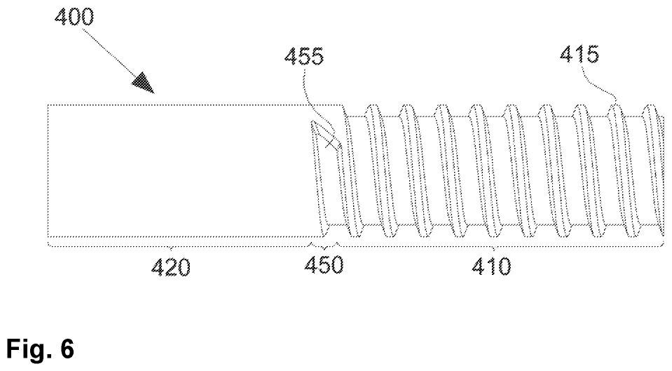

FIG. 6 illustration of an embodiment of a mandrel according to the invention.

FIG. 1 shows a cross-sectional view of a socket 100 as known in the art. The socket 100 comprises a body 101 with a first end 102 and a second end 103. A bore 104 extends through the body 101 from the first end 102 to the second end 103. The bore 104 comprises an inner thread that in case of the socket 100 as known in the art extends within the bore 104 from the first end 102 to the second end 103. The inner thread is formed by a helical notch 105. Thereby, the notch 105 forms a recess in the body 101 of the socket 100 within the bore 104. The notch 105, for example, may be cut into the bore 104 of the socket 100 by ease of a mandrel.

In case of the socket 100 as known in the art, the notch 105 comprises essentially the same depth along the entire length of the bore. The pitch of the notch 105 extending helically along the bore 104, i.e. the pitch of the inner thread, is the same along the entire length of the bore 104.

The notch 105 comprises restrictions 110, 115. Said restrictions 110, 115 may be referred to as lateral restrictions 110, 115, because they restrict the notch 105 to both sides relatively to the longitudinal extend of the notch 105. Since the notch 105 extends helically in the socket, a restriction 110 restricts the notch in direction of the first end 102 of the socket 100, whereas a restriction 115 restricts the notch in direction of the second end 103 of the socket 100.

The restrictions 110, 115 are formed by portions of the body 101 of the socket 100. If the notch 105 is, for example, cut into the body of the socket 100, the cutting edges form the restrictions 110, 115 of the notch 105. In this case, it may be said that the notch is formed by a recess, the walls of which form the restrictions 110, 115. Generally, it may also be said that the notch 105 is formed by protrusions, which are arranged between two turns of the notch 105. In this case, the walls of the protrusion form the restrictions 110, 115. In the illustration depicted in FIG. 1, the restrictions 110, 115 are formed by thread flanks of the inner thread.

When a fastening element with a threaded portion is placed within the bore of the socket 100, for example at the position of the first end in the direction of the second end, the threaded portion of the fastening element can engage with the notch 105 and can thereby be screwed into the socket 100. In case of the socket 100 as known in the art, the notch 105 at the first end of the socket is only accessible at a narrow angle range. If the threaded portion does not meet the notch 105 within this narrow angle range, the threaded portion of the fastening element cannot screw into the notch 105 and therefore not into the inner thread of the socket 100. Instead, the fastening element may slip off, push the socket 100 deeper into the drill hole or—in the worst case—damage the socket 100.

FIG. 2 depicts a cross-sectional view of an embodiment example of a socket 200 according to the invention. The socket 200 according to the invention comprises a body 201 with a first end 202 and a second end 203. A bore 204 extends through the body 201 from the first end 202 to the second end 203. The bore 204 comprises an inner thread. The inner thread is partially formed by a helical notch 205. As described above with respect to the state of the art, the notch 205 may, for example, be considered as a recess in the body 201 of the socket 200 in the area of the bore 204.

In case of the socket 200 according to the invention, the notch 205 forms at least partially the inner thread of the socket 200 and comprises restrictions 210, 215 in direction of the first end 202 and the second end 203 of the socket 200, similarly to the restrictions 110, 115 of the notch 105 of the socket 100.

The inner thread of the socket 200 according to the invention comprises several turns, wherein these turns may be referred to as convolutions of the inner thread. The number of the turns of the socket may be denoted as N, whereas the distance between two turns—as illustrated in FIG. 2—is denoted as the distance δ. δ may also be referred to as the slope of the inner thread or the pitch.

As is illustrated in FIG. 2, the socket 200 according to the invention distinguishes from the socket 100 shown in FIG. 1 in that in the area of the notch 205 does not comprise a restriction in direction of the first end 202 at the first turn of the inner thread.

This difference is also depicted in the perspective view of the sliced socket in FIG. 3a.

Starting at the first end 202 of the socket 200, there may be an area without an inner thread. This area therefore does not comprise any restrictions. There is no protrusion in this area or, in other words, the lateral surface of the bore in this area is in the same position as the bottom of the recess of notch 205.

The socket according to the invention always comprises an area, in which the inner thread only has a restriction in the direction of the second end. This will be illustrated with reference to the example of the embodiment depicted in FIGS. 3a and 3b.

The socket 200 depicted in FIGS. 3a, 3b comprises a bore with a circular cross-section. In this respect, two radii may be distinguished. The radius 11 refers to the radius up to the bottom of the notch, whereas radius r2 refers to the radius up to the protrusion that forms the restriction of the notch. The depth of the notch in FIG. 3b is denoted as t, such that the following applies to the illustrated embodiment:

r2+t=r1

This will be further illustrated with reference to FIG. 3b.

Looking at this illustration in FIG. 3a, the advantage of the area of the first turn of the inner thread having only a restriction 220 in the direction of the second end of the socket 200 becomes clear.

When a fastening element having a threaded portion is inserted into the bore at the position of the first end of the socket 200, the threaded portion of the fastening element can impact the restriction 220 at any position of the first turn of the inner thread. This enables the threaded portion of the fastening element to impact the restriction 220 and engage with the inner thread of the socket for any relative angle position between the threaded portion and the inner thread.

Preferably, the protrusion 225 is formed wedge-shaped at the transition from the first turn of the inner thread to the second turn of the inner thread. The wedge-like shape has the advantage that there does not occur any face at the transition of the restriction 220 of the first turn of the inner thread to the notch 205 of the second turn of the inner thread, which may form an obstacle that hinders the screwing in of a threaded portion of the fastening element.

The FIGS. 4a and 4b show a comparison of detailed views of the restrictions of a notch of a socket 100 as known in the art and a cleared first turn of a socket 200 according to the invention.

FIG. 4a shows the socket 100 of FIG. 1 and a detailed view of the restrictions 110, 115 of the notch 105 at a first end 102 of the socket 100. The restrictions 110, 115, which may be formed by thread flanks, restrict the impact positions of the threaded portion of a fastening element relative to the bore of the socket 100. Only when the threaded portion impacts the notch 105 within a narrow access area, no restriction 110 in direction of the first end of the socket 100 hinders the access of the threaded portion into the notch 105 and a penetration is possible.

In FIG. 4b, a detailed view of an embodiment example of a socket 200 according to the invention is shown. The notch 205 comprises a restriction 220 in direction of the second end in the area of the first turn of the inner thread, but is cleared with respect to the first end. This is illustrated in FIG. 4b by ease of the dashed area 230, which in comparison to the socket too known in the art is not present in the socket 200 according to the invention.

FIGS. 5a to 5c show an illustration of a penetration of a fastening element 300 into a socket 200 according to the invention.

The fastening element 300 comprises a protrusion 315, which forms a threaded portion of the fastening element 300. In FIG. 5a it is shown how the threaded portion 315 impacts the first turn of the inner thread of the socket 200 at an arbitrary position and is screwed in. In FIG. 5b it is shown how the fastening element moves within the first turn of the inner thread of the socket, while FIG. 5c finally shows how the threaded portion is screwed in further into the inner thread and how the protrusion 315 engages with the notch 205 of the inner thread of the socket 200.

FIG. 6 shows an illustration of an embodiment example of a mandrel 400 according to the invention.

The mandrel 400 comprises a cylindrical body having a first end and a second end. The mandrel comprises a first portion 410 arranged at the first end and a second portion 420 arranged in direction of the second end. The first portion 410 comprises a first helical protrusion formed at the outer surface of the first portion 410. The protrusion 415 is configured for forming a helical notch of an inner thread in a socket, for example notch 205 of a socket 200 according to the invention. Thereby, the helical protrusion 415 is restricted by thread flanks, wherein a first thread flank faces the first end of the cylindrical body and a second thread flank faces the second end of the cylindrical body. Between the convolutions of the helical protrusion, the first portion 410 comprises a first diameter.

The mandrel 400 further comprises a portion 420, which has a greater diameter as the first portion and is configured for forming an enlarged inner diameter within the socket. For example, the diameter of the second portion 420 may be equal to the diameter of the first portion 410 plus two times the height of the protrusion 415.

The mandrel 400 further comprises a transition portion 450, which is arranged between the first portion 410 and the second portion 420. The transition portion 450 comprises a second helical protrusion, which extends around the cylindrical body along an entire turn and has the same pitch as the first helical protrusion 415. The second helical protrusion comprises a thread flank, which faces the first end of the cylindrical body and transitions into the first thread flank of the first protrusion 415 form-fittingly. In direction of the second end 420 of the mandrel 400, the transition portion 450 does not comprise any restriction. The transition portion transitions form-fittingly into the second portion 420 having the diameter that is enlarged compared to the first portion 410.

As illustrated in FIG. 4, the transition portion 450 comprises a wedge-shaped recess 455. Said wedge-shaped recess can be used to create a wedge-shaped protrusion at the end of the first turn of the inner thread in a socket 200.

The above description contains embodiments of one or more embodiments of the invention. Of course, it is not possible to describe every conceivable combination of the components and methods of the invention in the above embodiments. Rather, the person skilled in the art will recognize that there are numerous other combinations of further embodiments. Accordingly, the described embodiments are intended to encompass all such further combinations, modifications, variations and embodiments that fall within the scope of the appended claims.

1. A socket (200) for receiving at least a portion of a fastening element (300),
with an inner thread, which is formed at least partially by a helical notch (205) within the socket (200), wherein the notch (205) comprises restrictions (210, 215) in the direction of a first and a second end of the socket (200), and
wherein the inner thread, in the area of a first turn adjacent to the first end (202) of the socket (200), comprises a restriction in the direction of the second end (203), but no restriction in the direction of the first end (202).

2. The socket (200) according to claim 1, wherein the socket (200), in the area of the turn of the inner thread, comprises an inner diameter, which corresponds to the inner diameter of the socket in the area of a second turn of the inner thread plus two times the depth of the notch (205).

3. The socket (200) according to claim 1, wherein the restriction (215) in the direction of the second end (203) at the end of the first turn of the inner thread together with the restriction (215) in the direction of the second end (203) at the beginning of the second turn of the inner thread forms a wedge-shaped protrusion (225).

4. The socket (200) according to claim 1, wherein the socket (200) is cylindrical.

5. The socket (200) according to claim 1, wherein the socket (200) at least partially consists of a plastic material.

6. A system comprising:
a socket (200) with
an inner thread, which is formed at least partially by a helical notch (205) within the socket (200), wherein the notch (205) comprises restrictions (210, 215) in the direction of a first and a second end (202, 203) of the socket (200), and
wherein the inner thread, in the area of a first turn adjacent to the first end (202) of the socket (200), comprises a restriction (215) in the direction of the second end (203), but no restriction in the direction of the first end (202); and
a fastening element (300) comprising:
at least one threaded portion (315), wherein the at least one threaded portion (315) comprises a diameter, which corresponds to the diameter of the inner thread of the socket (200).

7. The system according to claim 6, wherein the restriction (215) in the direction of the second end (203) of the sleeve (200) at the end of the first turn of the inner thread together with the restriction (215) in the direction of the second end (203) of the sleeve (200) at the beginning of the second turn of the inner thread forms a wedge-shaped protrusion (225).

8. A mandrel (400), comprising:
a cylindrical body with a first end and a second end, wherein the cylindrical body comprises:
a first portion (410) with a first helical protrusion (415) formed at the outer surface of the first portion (410) for forming a helical notch of an inner thread in a socket, wherein the helical protrusion is restricted by thread flanks, wherein a first thread flank faces towards the first end of the cylindrical body and a second thread flank faces towards the second end of the cylindrical body, a second portion (420) having a greater diameter than the first portion (410) for forming an enlarged inner diameter within the socket, and
a transition portion (450) arranged between the first portion (410) and the second portion (420), wherein the transition portion (450) comprises a second helical protrusion (415), which extends along the cylindrical body for an entire turn and comprises the same pitch as the first helical protrusion (415), wherein the second helical protrusion comprises a thread flank, which faces towards the first end of the cylindrical body and transitions form-fittingly to the first thread flank of the first protrusion and wherein the second helical protrusion does not comprise a restriction in the direction of the second end of the cylindrical body.

9. Mandrel (400) according to claim 8, wherein the second helical protrusion restricts a wedge-shaped recess (455) within the transition portion.

10. Mandrel (400) according to claim 9, wherein the second helical protrusion comprises two ends and the first end forms the form-fitting transition of the thread flank of the second protrusion to the first thread flank of the first protrusion and wherein a connection line between the first end of the second helical protrusion and the second end of the second helical protrusion forms the wedge-shaped recess (455).
